(19) United States
(12) Patent Application Publication
(10) Pub. No.: US 2012/0169169 A1
(43) Pub. Date: Jul. 5, 2012

(54) KINETIC ENERGY SUPPLEMENTARY DEVICE

(76) Inventor: Sung-Tsai Wu, Taoyuan City (TW)

(21) Appl. No.: 12/985,325

(22) Filed: Jan. 5, 2011

(51) Int. Cl. H02K 16/00

(52) U.S. Cl. 310/114

(57) ABSTRACT

A kinetic energy supplementary device includes an annular magnetizer set formed by permanent magnet and magnetizer. Moreover, the annular magnetizer set consists of one immovable first annular track type permanent magnet assembly, the rotatable second annular track type permanent magnet assembly and the rotatable in reversed directions annular track type magnetizer assembly. The first annular track type permanent magnet assembly and the second annular track type permanent magnet assembly are respectively concentrically arranged outside and inside of annular track type magnetizer assembly for causing an one-way magnetic force.

### BACKGROUND OF THE INVENTION

1. Field of the Invention

The present invention relates to a kinetic energy supplementary device, which provides one-way magnetic force subject to interaction among an annular track type magnetizer assembly and two annular track type permanent magnet assemblies, avoiding defects in the process of fabrication.

2. Description of the Related Art

Subject to the present acknowledge and application, permanent magnets are used for the functions of assistance and stabilization, for example, for speaker quality arrangement, register, attraction, motor assistance, switching and stabilization controls. However, the application of permanent magnets is constrained to the range of static functions, not able to direct a system or to establish an independent system. Magnetic force is a force brought about by a magnetic field. Further, magnets exert forces and torques on each other through the magnetic fields they create. Therefore, there is room for improvement in this regard. Magnetic fields have had many uses in ancient and modern society. Further, the Earth produces its own magnetic field that is important in navigation. The magnetic field of permanent magnets is quite complicated. Unfortunately, the concept of poles of magnetic charge does not accurately reflect what happens inside a magnet. Further understanding of magnetic force and studying in application of magnetic force can break through the current establishments, providing extra functions.

Therefore, how to solve the aforesaid problems and drawbacks is what the inventor of the present invention has been searching and studying to help users make improvements.

### SUMMARY OF THE INVENTION

The present invention has been accomplished under the circumstances in view. It is therefore the main object of the present invention to provide a kinetic energy supplementary device, which utilizes common adaptive annular magnetizer set for converting magnetic force into one-way magnetic force for application.

To achieve this and other objects of the present invention, a kinetic energy supplementary device comprises one annular track type magnetizer assembly, first and second annular track type permanent magnet assemblies and a change steering mechanism for causing rotation of said second annular track type permanent magnet assembly in a first direction relative to said first annular track type permanent magnet assembly during rotation of said annular track type magnetizer assembly in a second direction relative to said first annular track type permanent magnet assembly and reversed to said first direction so as to produce an one-way magnetic force.

Further, the first annular track type permanent magnet assembly comprises a first annular permanent magnet track having at least one first permanent magnet and at least one non magnetized material fixed mount arranged around an outside wall thereof and carrying the at least one first permanent magnet; the second annular track type permanent magnet assembly is surrounded by the first annular track type permanent magnet assembly, comprising one second annular permanent magnet track having at least one second permanent magnet and at least one non magnetized material fixed mount arranged around an inside wall thereof and carrying the at least one second permanent magnet; the annular track type magnetizer assembly surrounds the second annular track type permanent magnet assembly and being surrounded by the first annular track type permanent magnet assembly, comprising an annular magnetizer track having at least one magnetizer and at least one non magnetized material fixed mount arranged around an inside wall thereof and carrying the at least one magnetizer. The first annular permanent magnet track, the second annular permanent magnet track and the annular magnetizer track constitute one annular magnetizer set.

Further, the first annular track type permanent magnet assembly comprises a plurality of the first permanent magnets carried on at least one non magnetized material fixed mount around the outside wall of the first annular permanent magnet track and kept apart from one another; the second annular track type permanent magnet assembly comprises a plurality of the second permanent magnets carried on at least one non magnetized material fixed mount around the inside wall of the second annular permanent magnet track and kept apart from one another; the annular track type magnetizer assembly comprises a plurality of magnetizers carried on at least one non magnetized material fixed mount around the inside wall of the annular magnetizer track and kept apart from one another.

Further, said first permanent magnet which is set on the first annular permanent magnet track, said second permanent magnet which is set on the second annular permanent magnet track and said magnetizer which is set on the annular magnetizer track are different in amount and arrangement to form the combinational mechanism of drawing-close and transforming magnetic force direction.

Further, each annular magnetizer set is drawn close with specific angle respectively, and then multiple sets form the one-way magnetic force density.

Further, magnetizer comprises multiple magnetizer layers. Each magnetizer layer comprises a plurality of magnetic conductive elements arranged in a stack and separated from one another by a non magnetized material.

Further, increasing the number of the combination of permanent magnet and magnetizer in annular magnetizer set and broadening the working distance between shaft core and magnetic force, one-way magnetic force is enhanced.

The one-way kinetic energy supplementary device further comprises a first track holder carrying the first annular permanent magnet track, a second track holder carrying the annular magnetizer track, a third holder carrying the second annular permanent magnet track and a change steering mechanism for causing rotation of the second track holder with the annular magnetizer track and the third track holder with the second annular permanent magnet track in two reversed directions relative to the first track holder with the first annular permanent magnet track that is kept immovable for maintaining the stabilization of the one-way magnetic force.

Further, the interaction among said annular track type magnetizer assembly and the two annular track type permanent magnet assemblies includes a magnetic attractive force of magnetic attraction and a magnetic repelling force of magnetic repulsion.

When compared to conventional techniques, the invention is characterized by the application of a change steering mechanism to cause rotation of an annular magnetizer track and a second annular permanent magnet track in two reversed directions relative to a first annular permanent magnet track so that an one-way magnetic force is produced subject to the interaction of the magnetic attraction between the annular magnetizer track and the first annular permanent magnet track with the magnetic attraction between the annular magnetizer track and the second annular permanent magnet track form transforming magnetic force direction.

### BRIEF DESCRIPTION OF THE DRAWINGS

FIG. 1 is a schematic top view of a kinetic energy supplementary device in accordance with the present invention.

FIG. 2 is an elevational view of the kinetic energy supplementary device in accordance with the present invention.

FIG. 3 is a schematic partial view, in an enlarged scale, of an internal part of the kinetic energy supplementary device in accordance with the present invention.

FIG. 4 is an exploded view of the kinetic energy supplementary device in accordance with the present invention.

FIG. 5 is another exploded view of the kinetic energy supplementary device in accordance with the present invention.

FIG. 6 is a schematic drawing of the present invention, illustrating an operating status of the kinetic energy supplementary device in accordance with the present invention.

FIG. 7 corresponds to FIG. 2, illustrating a status of magnetic induction operation.

FIG. 8 corresponds to FIG. 7, illustrating another status of magnetic induction operation.

FIG. 9 is an exploded view of the change steering mechanism of the kinetic energy supplementary device in accordance with the present invention.

### DETAILED DESCRIPTION OF THE PREFERRED EMBODIMENT

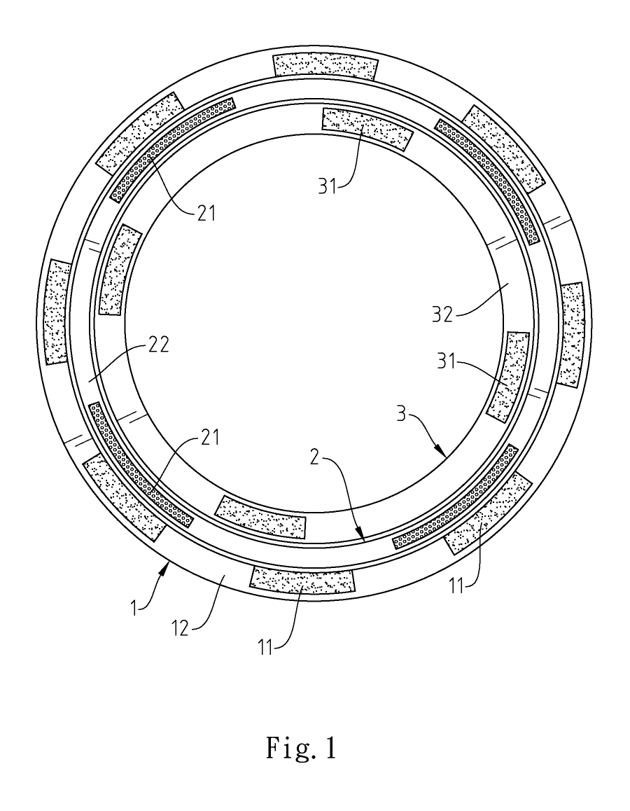

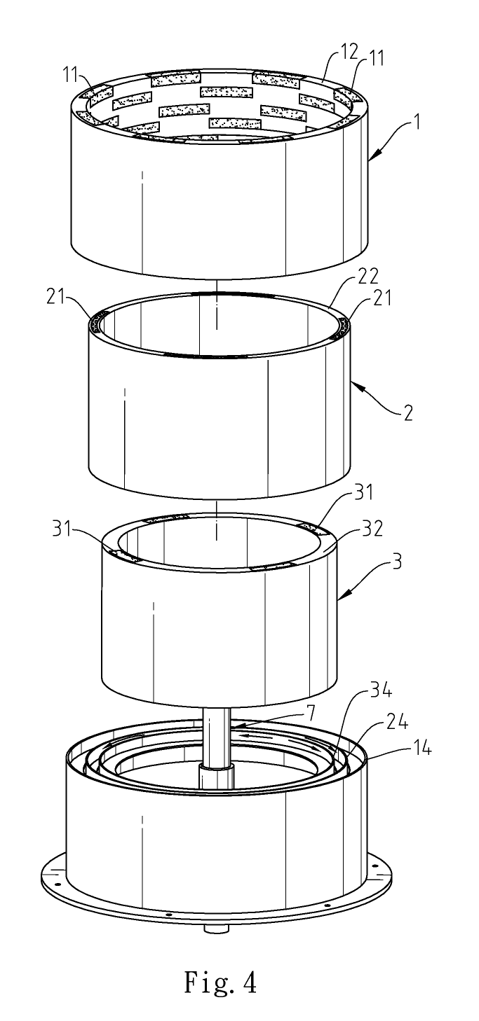

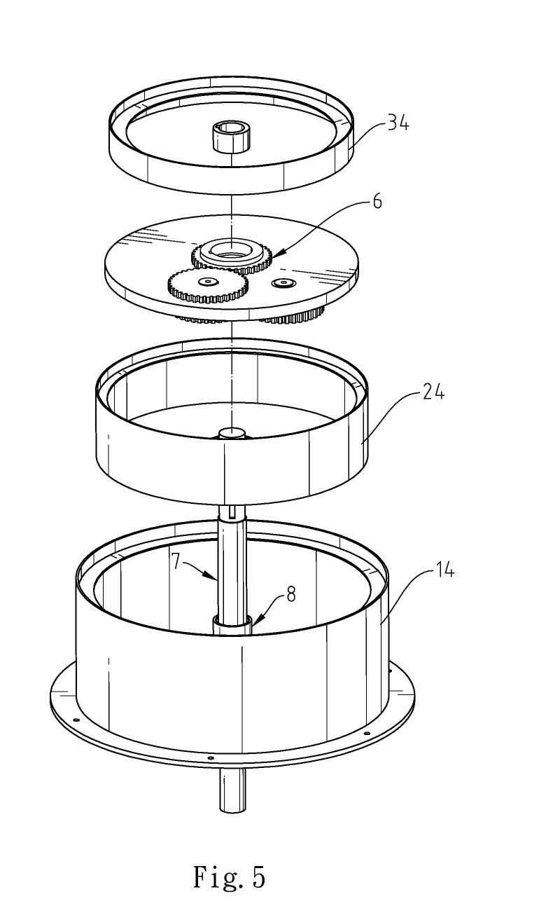

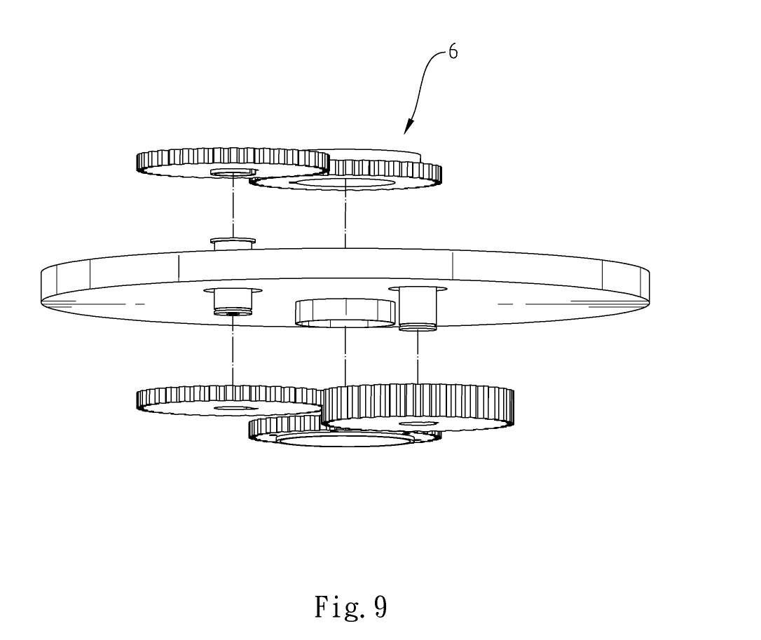

Referring to FIGS. 1, 2, 4, 5 and 9, a kinetic energy supplementary device in accordance with the present invention is based on an architecture consisting of one annular track type magnetizer assembly and two annular track type permanent magnet assemblies.

In one embodiment of the present invention, the kinetic energy supplementary device comprises a first annular permanent magnet track 1 having at least one first permanent magnet 11 and at least one non magnetized material fixed mount 12 arranged around the outside wall thereof in at least one round, an annular magnetizer track 2 having at least one magnetizer 21 and at least one non magnetized material fixed mount 22 arranged around the inside wall in at least one round, and a second a annular permanent magnet track 3 having at least one second permanent magnet 31 and at least one non magnetized material fixed mount 32 arranged around the inside wall thereof in at least one round.

The first annular permanent magnet track 1 surrounds the annular magnetizer track 2 that surrounds the second annular permanent magnet track 3. Thus, the first annular permanent magnet track 1, the annular magnetizer track 2 and the second annular permanent magnet track 3 constitute one permanent magnet and magnetizer track set in which the first annular permanent magnet track 1 is immovable, the annular magnetizer track 2 and the second annular permanent magnet track 3 are rotatable relative to the first annular permanent magnet track 1.

The kinetic energy supplementary device further comprises a change steering mechanism 6, a transmission shaft 7, a first track holder 14, a second track holder 24 and a third track holder 34. The first annular permanent magnet track 1 is mounted on the casing of the first track holder 14. The annular magnetizer track 2 is mounted on the second track holder 24. The second annular permanent magnet track 3 is mounted on the third track holder 34. The third track holder 34 is fixedly connected with shaft core to the transmission shaft 7. The change steering mechanism 6 is fastened to a bush 8 on the casing of the transmission shaft 7 and coupled to the second track holder 24 and the third track holder 34 for causing rotation of the second track holder 24 in the reversed direction during rotation of the third track holder 34 with the transmission shaft 7 relative to the first track holder 14 and the first annular permanent magnet track 1. Subject to the functioning of the change steering mechanism 6, the first track holder 14 and the second track holder 24 can be rotated counter-clockwise or clockwise, and the first track holder 14 and the third track holder 34 is rotated with the transmission shaft 7 clockwise or counter-clockwise relative to the first track holder 14. Thus, the annular magnetizer track 2 and the second annular permanent magnet track 3 can be rotated in two reversed directions relative to the first annular permanent magnet track 1 that is kept immovable. By the interaction of different direction of rotation, magnetic force is changed to produce kinetic energy supplementary device with one-way magnetic force.

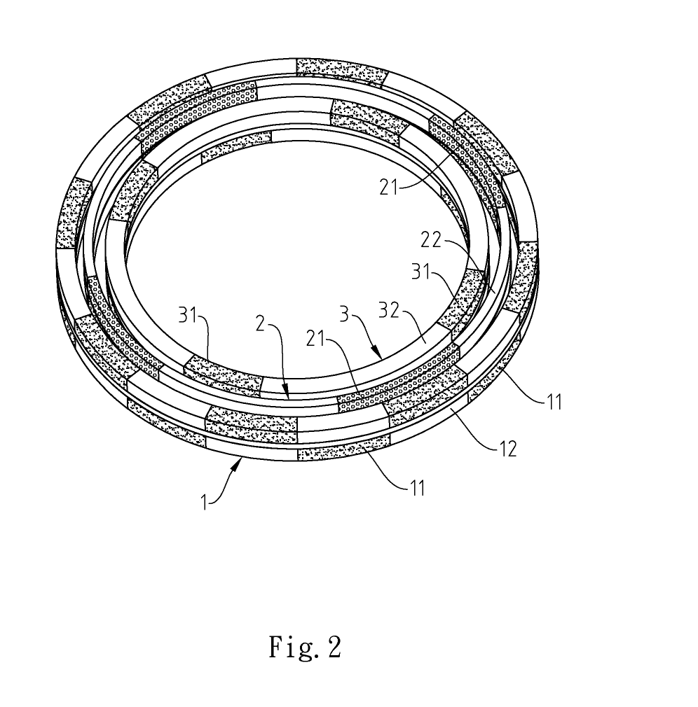

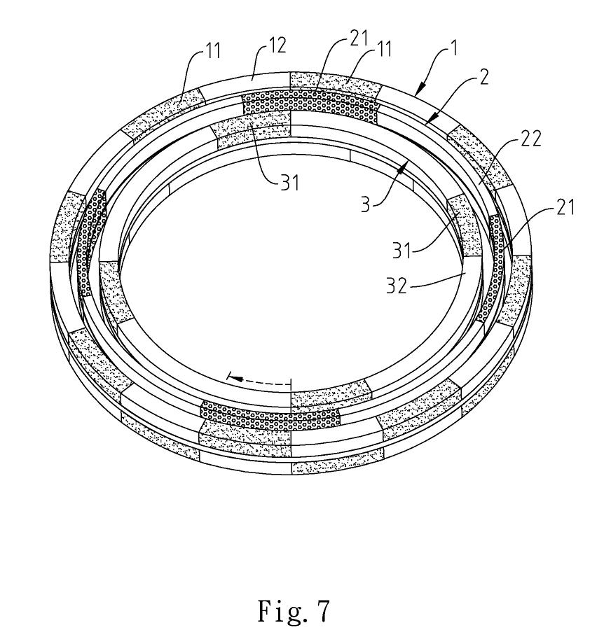

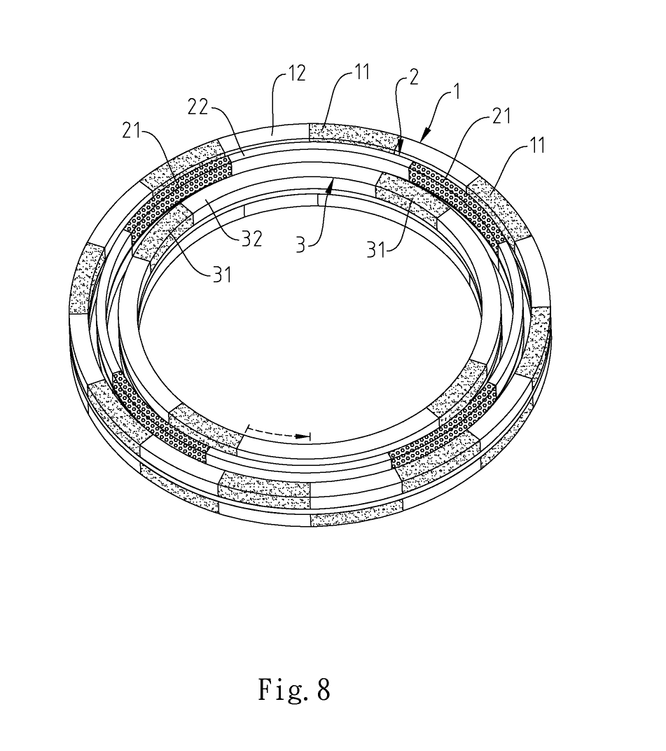

Referring to FIGS. 7 and 8 and FIG. 2 again, the set drawn close by the annular magnetizer set includes the different amount and the different arrangement of the first permanent magnets 11, the number of the magnetizers 21 and the second permanent magnets 31. When the first annular permanent magnet track 1 and the second annular permanent magnet track 3 are in operation, magnetizer 21 forms the interaction of magnetic force between the first permanent magnet 11 and the second permanent magnet 31 to produce transferring magnetic force directions between the first permanent magnet 11 and the second permanent magnet 31. As the both ends magnetic force of magnetic attractions between the first permanent magnets 11 and the second permanent magnets 31 are not equal, a reminder is left after setting off the magnetic attractions from the first permanent magnets 11 and the second permanent magnets 31 to form one-way magnetic force, thereby producing a kinetic energy.

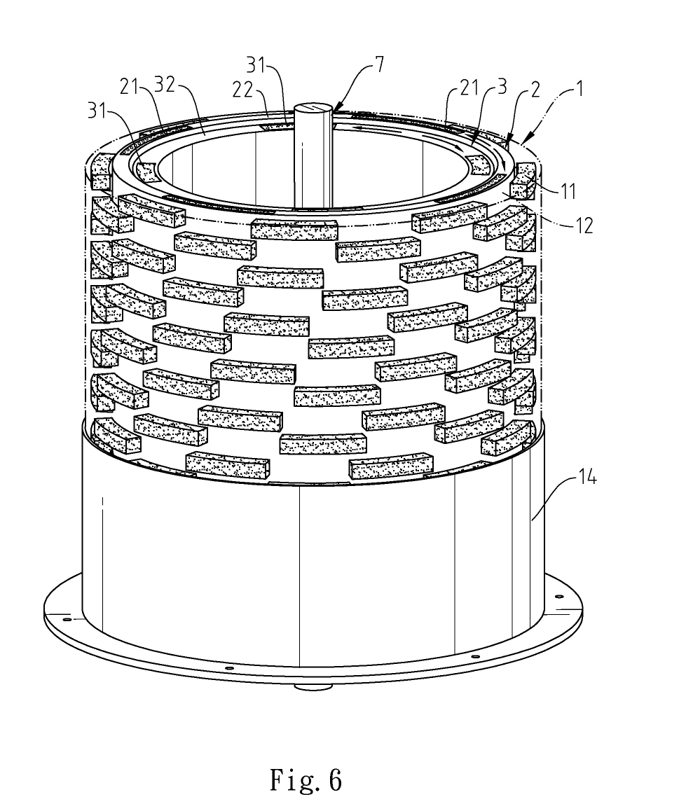

Based on the aforesaid structure and coposition design, the functioning and effects of the present invention will be fully understood with reference to FIGS. 1, 2, 4, 5 and 6. As illustrated, the first annular permanent magnet track 1, the annular magnetizer track 2 and the second annular permanent magnet track 3 constitute one annular magnetizer set to further draw close multiple sets. The sets drawn close by magnetizer set can be respectively mounted therein at least one change steering mechanism 6. Each annular magnetizer set is drawn close with specific angle respectively, and then multiple sets form the reminder that is left after setting off from both ends magnetic attraction, and then form the one-way magnetic force and extension of output.

When increasing the number of drawing-close multiple sets with special angle, the single-ended one-way magnetic force producing from the sets is stronger and dynamic energy supplementary function is stronger and completed. Thus, the user can increase the number of the annular magnetizer sets according actual requirements settle on different functions.

Referring to FIGS. 1, 2, 4 and 6, the invention comprises an annular magnetizer set formed by permanent magnet and magnetizer. Moreover, the annular magnetizer set consists of one first annular permanent magnet track 1, one annular magnetizer track 2 and one second annular permanent magnet track 3, wherein the first annular permanent magnet track 1 has mounted therein at least one first permanent magnet 11; the annular magnetizer track 2 has mounted therein at least one magnetizer 21; the second annular permanent magnet track 3 has mounted therein at least one second permanent magnet 31. Further, the first annular permanent magnet track 1 is mounted on the first track holder 14 that is immovable; the annular magnetizer track 2 is mounted on the second track holder 24 that is rotatable clockwise or counter-clockwise; the second annular permanent magnet track 3 is mounted on the third track holder 34 that is rotatable counter-clockwise or clockwise. In one example of the present invention, the annular magnetizer track 2 is mounted on the second track holder 24 that is rotatable clockwise, and the second annular permanent magnet track 3 is mounted on the third track holder 34 that is rotatable counter-clockwise during clockwise rotation of the annular magnetizer track 2 with the second track holder 24. In another example of the present invention, the annular magnetizer track 2 is mounted on the second track holder 24 that is rotatable counter-clockwise, and the second annular permanent magnet track 3 is mounted on the third track holder 34 that is rotatable clockwise during counter-clockwise rotation of the annular magnetizer track 2 with the second track holder 24. Further, during the functioning of the change steering mechanism 6, the second track holder 24 can be rotated clockwise or counter-clockwise relative to the third track holder 34 is rotated counter-clockwise or clockwise. Subject to the functioning and effect of interaction among magnetizer 21 which is set on the rotatable annular magnetizer track 2, the permanent magnet 31 which is set on the the rotatable second annular permanent magnet track 3, and the permanent magnet 11 which is set on the immovable first annular permanent magnet track 1, the arrangement of the common adaptive magnetizer 21 which integrates with the magnetic force of the first permanent magnet 11 and the magnetic force of the second permanent magnet 31 constructs the change of magnetic force direction including a magnetic attractive force of magnetic attraction and a magnetic repelling force of magnetic repulsion, and uses the switching and accumulation of different constriction and different transferring to produce and lead the magnetic force which exists and reciprocate at different position and different amount of magnetic force to release and forms single-ended one-way magnetic force.

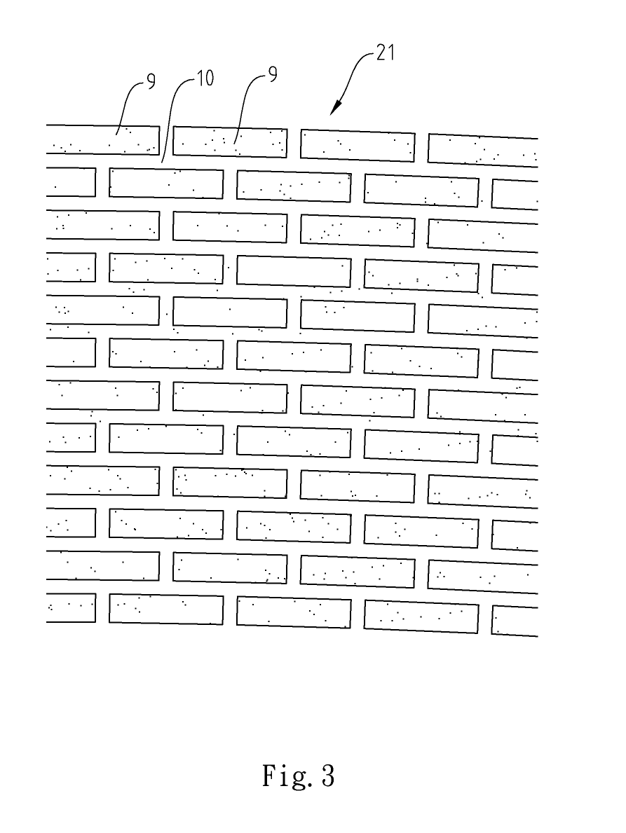

Referring to FIGS. 1, 2, 3 and 6 again, to harmonize functioning of the at least one magnetizer 21 with the at least one first permanent magnet 11 and the at least one second permanent magnet 31, each magnetizer 21 is made in a multi-layer structure, each layer comprising a plurality of magnetic conductive elements 9 arranged in a stack and separated from one another by a non magnetized material 10. Subject to this magnetizer design, drag force is minimized during operation, and therefore the one-way magnetic force thus produced is enhanced for different applications.

In conclusion, the invention provides a kinetic energy supplementary device, which has the advantages over the conventional techniques as follows:

The kinetic energy comprises the immovable first annular permanent magnet track 1, the rotatable annular magnetizer track 2 and the rotatable second annular permanent magnet track 3 to constitute the annular magnetizer set. The annular magnetizer set consists of different switching and the drawing-close combination with specific angle to form the one-way reminder that is left after setting off. The first annular permanent magnet 1, annular magnetizer track 2 and the second annular permanent magnet track 3 comprise respectively the first permanent magnet 11, magnetizer 21 and the third permanent magnet 31. Subject to the functioning of change steering mechanism 6, annular magnetizer track 2 and the second annular permanent magnet track 3 form two reversed directions that are rotated clockwise and counter-clockwise, and then construct magnetizer 21 to form the interaction of magnetic force between the first permanent magnet 11 and the second permanent magnet 31 to change magnetic force directions and release magnetic force in different amount to form two-ended unequal sum of magnetic attraction to be larger, and then construct and enhance one-way magnetic force. According to the mechanism illustrated as above, the present invention transfers effectively magnetic force into the points of magnetic force that can be composed and organized, and draw close multiple sets with specific angle form the connection of the relation of surrounding thing, thus user can free increase the number of annular magnetizer set subject to practical requirements. Wherein increasing the number of the combination of permanent magnet and magnetizer in annular magnetizer set, and the broader working distance between shaft core and magnetic force, its performance will be upgraded for various applicants.

Although a particular embodiment of the invention has been described in detail for purposes of illustration, various modifications and enhancements may be made without departing from the spirit and scope of the invention.

What the invention claimed is:

1. A kinetic energy supplementary device, comprising one annular track type magnetizer assembly, first and second annular track type permanent magnet assemblies and a change steering mechanism for causing rotation of said second annular track type permanent magnet assembly in a first direction relative to said first annular track type permanent magnet assembly during rotation of said annular track type magnetizer assembly in a second direction relative to said first annular track type permanent magnet assembly and reversed to said first direction so as to produce an one-way magnetic force.

2. The kinetic energy supplementary device as claimed in claim 1, wherein said first annular track type permanent magnet assembly comprises one first annular permanent magnet track having at least one first permanent magnet and at least one non magnetized material fixed mount arranged around an outside wall thereof and carrying said at least one first permanent magnet; said second annular track type permanent magnet assembly is surrounded by said first annular track type permanent magnet assembly, comprising one second annular permanent magnet track having at least one second permanent magnet and at least one non magnetized material fixed mount arranged around an inside wall thereof and carrying said at least one second permanent magnet; said annular track type magnetizer assembly surrounds said second annular track type permanent magnet assembly and being surrounded by said first annular track type permanent magnet assembly, comprising an annular magnetizer track having at least one magnetizer and at least one non magnetized material fixed mount arranged around an inside wall thereof and carrying said at least one magnetizer; said first annular permanent magnet track, said second annular permanent magnet track and said annular magnetizer track constitute one annular magnetizer set.

3. The kinetic energy supplementary device as claimed in claim 2, wherein said first annular track type permanent magnet assembly comprises a plurality of the first permanent magnets carried on at least one non magnetized material fixed mount around the outside wall of said first annular permanent magnet track and kept apart from one another; said second annular track type permanent magnet assembly comprises a plurality of the second permanent magnets carried on at least one non magnetized material fixed mount around the inside wall of said second annular permanent magnet track and kept apart from one another; said annular track type magnetizer assembly comprises a plurality of magnetizers carried on at least one non magnetized material fixed mount around the inside wall of said annular magnetizer track and kept apart from one another.

4. The kinetic energy supplementary device as claimed in claim 2, wherein said first permanent magnet which is set on the first annular permanent magnet track, said second permanent magnet which is set on the second annular permanent magnet track and said magnetizer which is set on the annular magnetizer track are different in amount and arrangement to form the combinational mechanism of drawing-close and transforming magnetic force direction.

5. The kinetic energy supplementary device as claimed in claim 2, wherein each annular magnetizer set is drawn close with specific angle respectively, and then multiple sets form the one-way magnetic force density.

6. The kinetic energy supplementary device as claimed in claim 1, wherein each said magnetizer comprises multiple magnetizer layers, each said magnetizer layer comprising a plurality of magnetic conductive elements arranged in a stack and separated from one another by a non magnetized material.

7. The kinetic energy supplementary device as claimed in claim 2, wherein increasing the number of the combination of permanent magnet and magnetizer in annular magnetizer set, and broadening the working distance between shaft core and magnetic force, one-way magnetic force is enhanced.

8. The kinetic energy supplementary device as claimed in claim 2, further comprising a first track holder carrying said first annular permanent magnet track, a second track holder carrying said annular magnetizer track, a third holder carrying said second annular permanent magnet track and a change steering mechanism for causing rotation of said second track holder with said annular magnetizer track and said third track holder with said second annular permanent magnet track in two reversed directions relative to said first track holder with said first annular permanent magnet track that is kept immovable for maintaining the stabilization of the one-way magnetic force.

9. The kinetic energy supplementary device as claimed in claim 1, wherein the interaction among said annular track type magnetizer assembly and said two annular track type permanent magnet assemblies includes a magnetic attractive force of magnetic attraction and a magnetic repelling force of magnetic repulsion.
